(19) United States
(12) Patent Application Publication
(10) Pub. No.: US 2008/0172723 A1
(43) Pub. Date: Jul. 17, 2008

(54) System and method of collecting data in an access control system

(76) Inventors: Dominic Pesapane, Cheshire, CT (US); Michael Cote, Terryville, CT (US); Gary Lavelle, Avon, CT (US)

Correspondence Address: MICHAEL BEST & FRIEDRICH LLP, 100 EAST WISCONSIN AVE, SUITE 3300, MILWAUKEE, WI, 53202-4108, US

(21) Appl. No.: 11/654,207

(22) Filed: Jan. 16, 2007

(51) Int. Cl. G06F 7/04

(52) U.S. Cl. 726/5

(57) ABSTRACT

A method of collecting data in a lock system. The method includes providing each user with a credential that contains user information, presenting the credential at an off-line access point, and reading the user information from the credential. The method also includes analyzing the user information at the first off-line access point to determine if access to the first off-line access point should be allowed, sending event data from the off-line access point to the credential, and selectively overwriting existing event data and storing the sent event data on the credential. The invention further includes presenting the credential at an on-line access point and reading the user data and reading the event data.

### BACKGROUND

The present invention relates to an access control system that includes both on-line and off-line access points. More particularly, the present invention relates to a system and method for collecting access point event data from both off-line and on-line access points.

Current access control systems may include on-line access points that are directly connected to a central data storage system and/or off-line access points that are not connected to the central data storage system. The off-line access points are convenient in that they do not require the addition of wiring or other connection means between the access point and the central data storage system. However, off-line locks generally require periodic access to download any event data (e.g., access logs, access denial lists, access grant list, lock status, faults, etc.) that may be stored. Thus, these systems generally require a user to periodically connect to each of the off-line locks to download this data. The data is then uploaded to the central data storage system for analysis and storage.

This type of system can be labor intensive and reduces the flexibility of the system. For example, global security changes, the addition of new users, the removal of old users, changes in codes or passwords, and the like cannot be easily transferred to the off-line locks. Rather, such information must be transferred during the periodic downloads.

### SUMMARY

In one embodiment, the invention provides a method of collecting data in a lock system. The method includes providing each user with a credential that contains user information, presenting the credential at an off-line access point, and reading the user information from the credential. The method also includes analyzing the user information at the first off-line access point to determine if access to the first off-line access point should be allowed, sending event data from the off-line access point to the credential, and selectively overwriting existing event data and storing the sent event data on the credential. The invention further includes presenting the credential at an on-line access point and reading the user data and reading the event data.

In another embodiment, the invention provides a method of collecting data in a lock system in which each user possesses a credential that includes user information. The method includes presenting the credential at an off-line access point, storing event data from the off-line access point on the credential, and presenting the credential at an on-line access point. The method also includes transferring the event data from the credential through the on-line access point to a central system, storing verification data on the credential, re-presenting the credential at the off-line access point, and erasing event data from the off-line access point in response to receipt of the verification data.

In yet another embodiment, the invention provides a method of collecting data in a lock system. The method includes presenting a credential at an on-line access point. The credential includes event data and user data. The method also includes storing the event data in a central system, storing verification data on the credential, and reading the user data and the event data from the credential at a first off-line access point. The method also includes selectively erasing event data that corresponds to the verification data from the first off-line access point, and storing first off-line access point event data on the credential. The first off-line access point event data includes a priority assigned by the first off-line access point.

### BRIEF DESCRIPTION OF THE DRAWINGS

FIG. 1 is a schematic illustration of an access control system that controls access to a plurality of access points;

FIG. 2 is a schematic illustration of a credential;

FIG. 3 is a flow chart illustrating a portion of the function of the access control system of FIG. 1;

FIG. 4 is a flow chart illustrating another portion of the function of the access control system of FIG. 1;

FIG. 5 is a schematic illustration of an on-line access point of FIG. 1; and

FIG. 6 is a schematic illustration of an off-line access point of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

FIG. 1 schematically illustrates a portion of an access control system 10 that controls access to a plurality of access points 15. In most constructions, each of the access points 15 are disposed in a secured portion of a building such as a floor or portion of a floor, in an entire building, or in a group of buildings. The illustration of FIG. 1 includes only a few access points 15 for simplicity. However, one of ordinary skill in the art will understand that fewer access points 15 could be controlled as described herein as well as many times more access points 15 than those illustrated in FIG. 1.

The system 10 of FIG. 1 includes a central system or central computer system 20 that stores, and in some constructions, analyzes event data. In addition, the central computer system 20 may store other information such as valid user lists, valid access points for each user, passwords or personal identification numbers for each user, status of the various access points, and status of each user, to name a few. In preferred constructions, the central computer system 20 includes a data storage system 25, a processor 30, and communication links 35 to allow for the transfer of data to and from the central computer system 20.

As illustrated in FIG. 1, the central computer system 20 is in communication with an on-line access point 40, sometimes referred to as an on-line lock 45 that may be associated with an access point 15 (e.g., a door, gate, window, portal, drawer, etc.). In the illustrated construction, the communication is provided by one or more wires that interconnect the on-line access point 40 and the central computer 20. Of course, other constructions may employ other communications such as but not limited to wireless communication. It should be noted that the illustrated construction includes only one on-line access point 40. However, other constructions may include more than one on-line access point 40. For example, a system that controls access to multiple buildings may include on-line access points at the main entrance of each building. Still other constructions include an on-line access point that is not associated with an access point. In these arrangements, the on-line access point only provides access to the central computer system 20 to allow for the transfer of data.

As shown in FIG. 5, the on-line lock 45 includes a reader capable 50 of reading user data from a credential 55. The on-line lock 45 may also include any of a data storage system 60, a processor 65, communications hardware 70 that facilitate communication between the on-line lock 45 and the central computer 20, and a lock mechanism 75 operable to control access to the access point 40 (e.g., a solenoid-operated lock mechanism). Thus, in the illustrated construction, one or both of the on-line lock 45 and the central computer 20 are capable of making the access decisions for the on-line access point 40. As discussed, some constructions may omit the lock mechanism 75 and simply provide an on-line access point 40 to facilitate data transfer.

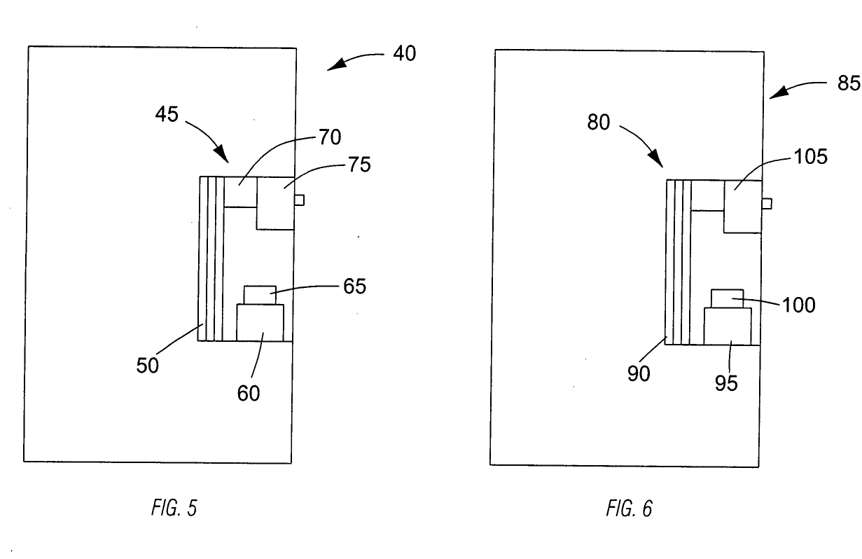

Beyond the on-line access point 40 are several access points 15 for which access is controlled by off-line locks 80. Each off-line lock 80 is coupled to an access point 15 to define an off-line access point 85. As shown in FIG. 6, the off-line locks 80 or off-line access points 85 (e.g., a door, gate, window, portal, drawer, etc.) are similar to the on-line lock 45 in that they each include a reader 90 capable of reading user data from the credential 55. In addition, off-line locks 80 may include any of a data storage system 95, a processor 100, and a lock mechanism 105 operable to control access to the associated access point 85.

It should be noted that FIG. 1 illustrates only one on-line access point 40. However, other constructions may employ multiple on-line access points 40 in conjunction with multiple off-line access points 85. There is no requirement that only one on-line access point 40 be employed or that the ratio of on-line access points 40 to off-line access points 85 is as illustrated in FIG. 1.

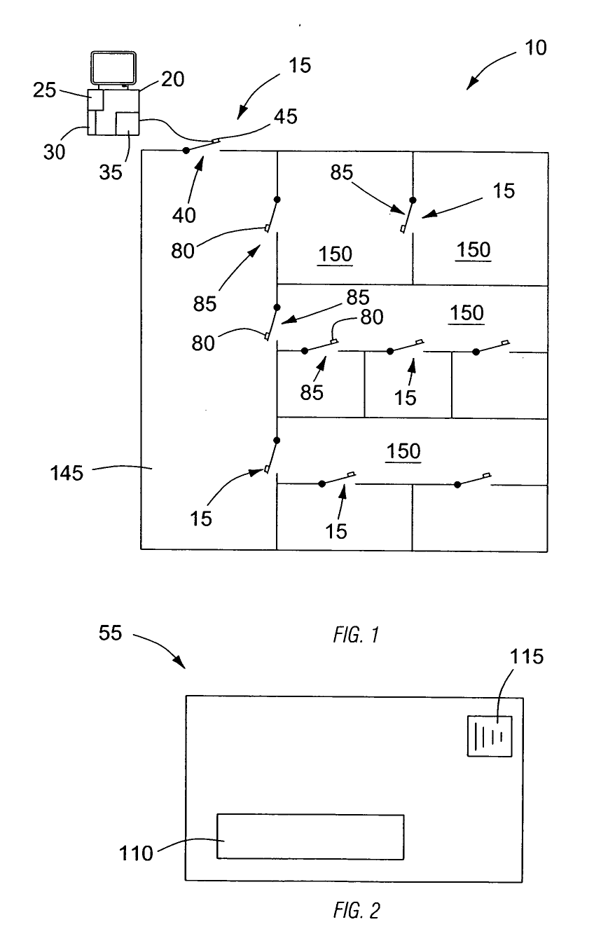

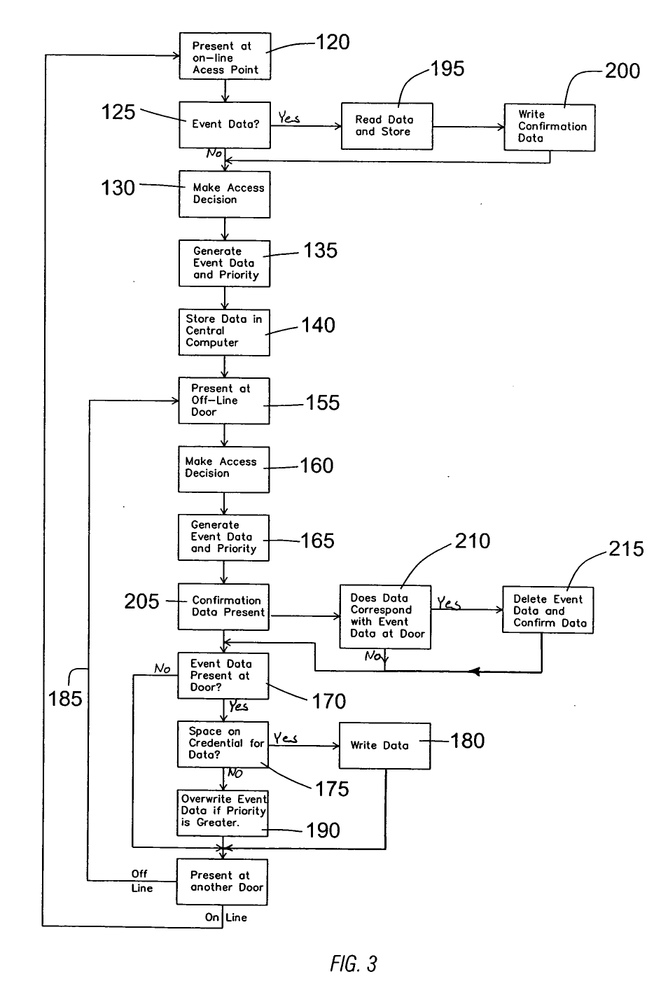

FIG. 2 schematically illustrates one possible credential 55 suitable for use with the access system 10 of FIG. 1. The credential 55 includes memory 110 that stores user information as well as event data as will be discussed below. In addition, the credential 55 includes a communication interface 115 that may be in the form of a transceiver that transmits user information and receives data from the various off-line locks 80 and on-line locks 45. In other constructions, the credential 55 includes other communication interfaces. For example, another construction employs a magnetic strip rather than the transceiver. In fact, many different credentials 55 may be employed so long as the credential 55 is capable of transferring and storing data between the credential 55, off-line locks 80 and on-line locks 45.

In use, each user has a credential 55 that contains unique user information. The user information may be assigned and stored by the central computer 20. In addition, each user may be assigned certain access rights. For example, the user may be limited to access at certain access control points 15 or may be allowed limited entry based on the time of day or the particular date or day of the week.

To enter the controlled portion 10 illustrated in FIG. 1, the user presents the credential 55 to the on-line lock 45 as illustrated in FIG. 3 at block 120. The on-line lock 45 checks for event data on the credential 55 as will be discussed below and as shown at block 125. If no event data is present, the on-line lock 45 reads or receives the user information from the credential 55 and either makes the access decision on its own or transfers the user information to the central computer to allow the central computer to make the access decision as shown at block 130. If access is granted, based at least partially on the user information, the on-line lock 45 moves the lock-mechanism 75 to an unlocked position and the user gains access to, or passes through the on-line access point 40.

The attempted entry of the user at the on-line access point 40, as well as the denial or grant of access, generates event data (block 135) that may be stored by the central computer for later use and analysis (block 140). Because the on-line lock 45 is connected to the central computer 20, the event data can be immediately transferred to the central computer 20 and stored.

The user enters a first space 145 that provides access to additional spaces 150 that are secured by off-line access points 85 that include off-line locks 80. The procedure for entry to any one of these access points 85 is similar. The user presents the credential 55 at the access point 85 for which access is desired as shown in block 155. The off-line lock 80 reads the user information from the credential 55, analyzes the user information (e.g., compares the user information to stored user information for users allowed access) and makes an access decision (block 160) at least partially based on the user data. The reading of the user data, as well as the access decision may generate event data (block 165) that is stored in the memory 95 of the off-line lock 80. If the access decision is to allow entry, the off-line lock 80 actuates the lock mechanism 105 and unlocks the access point 85 for entry. This process is repeated at each off-line lock 80 to determine if entry should be granted.

Each event generated, whether at an on-line lock 45 or an off-line lock 80, can be assigned an event priority (blocks 135, 165) that approximately corresponds to the importance of the event. For example, in one arrangement, an attempted access receives a relatively low priority of five, while a denied access receives a higher event priority of three. An even more important event, such as granted access, may receive an event priority of two, while a device failure may receive an event priority of one. Additionally, the importance of a particular event may vary depending on the location of the access point 15. Particularly important access points 15 may produce events with priorities that are one or more levels more important than they would be at less important access points 15. For example, a particular access point 15 may generate an event priority of two for any attempted access, and an event priority of one for any access gained or denied.

Each time the credential 55 is presented at an off-line lock 80, the user information is read to allow for access decisions (block 160). However, event data stored in the off-line lock 80 is also downloaded to the credential 55 (blocks 170, 175, 180). Because the credential 55 has limited memory 110, the data is stored in its order of importance (i.e., data having the highest event priority is stored first). In order to facilitate the storage of the proper data given the short period of communication between the credential 55 and the off-line lock 80, one construction orders the event data within the off-line lock 80 based on the event priority. Thus, the data is sent to the credential 55 in the proper order. Other constructions may reorder the data after it is stored on the credential 55 or may provide pointers to the data. The pointers could be rearranged based on the event priority of the data to which they point. Thus, following the example discussed above, as the user attempts to gain access to the first off-line access point 85, the off-line lock 80 transfers event data to the credential 55. As the user proceeds to a second off-line lock 80 and even a third or fourth off-line lock 80, the process is repeated as shown in path 185 (i.e., event data is downloaded to the credential 55 if space is available, and access decisions are made). However, at some point, the data storage capacity of the credential 55 is reached. Once reached, additional data is stored only if it has an event priority that is higher than the data already stored as shown in block 190. Stored data is deleted or overwritten to accommodate the higher priority data as may be necessary.

When the user again attempts to gain entry at the on-line access point 40 (block 120), the user data is read from the credential 55 as before. In addition, all of the event data is uploaded through the on-line lock 45 to the central computer 20 as shown in block 195. After the data is stored, confirmation data corresponding to the uploaded event data is downloaded to, and stored on the credential as shown in block 200. The on-line lock 45 or the central computer 20 than makes the access decision (block 130), and presuming access is granted actuates the lock mechanism 75 to allow the user to pass through the on-line access point 40.

The user then moves to the off-line access point 85 and attempts to gain access (block 155). The user information as well as the confirmation data is read (blocks 160 and 205). If any of the confirmation data matches event data stored in the off-line lock 80, the event data is deleted from the off-line lock 80 as it has been successfully transferred to the central computer 20 as shown in blocks 210 and 215. Similarly, the confirmation data that matched the event data can be deleted from the credential 55 to free memory for additional event data. The user data is used to make the access decision (block 160) and new event data is downloaded to the credential 55 (block 170). This process is repeated for each user and each access point 15 accessed.

In many cases, the same event data may be downloaded to multiple user credentials 55. The first user to access an on-line access point 40 transfers the data to the central computer 20 and receives the confirmation data. All subsequent users simply receive the confirmation data, which replaces the actual event data. The first of these users that accesses the off-line access point 85 transfers the confirmation data such that the event data is erased from the off-line lock 80. Any subsequent users simply have the confirmation data erased when they access the off-line lock 80. This system assures that all of the downloaded data is eventually transferred to the central computer 20. In addition, the off-line access point 85 can add event data, or change the confirmation data, to the credentials 55 to indicate that the off-line data has received the confirmations. Once the central computer 20 receives this information, the on-line access point 40 will stop adding the confirmation data to the credentials 55.

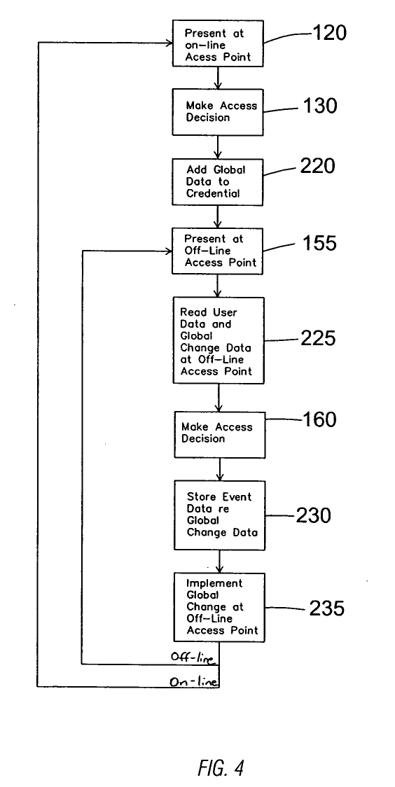

In addition to transferring event data, the present system is capable of transferring changes to the security system such as global security changes, the addition of new users, the removal of old users, changes in codes or passwords, and the like. As illustrated in FIG. 4, the desired data is downloaded to one or more user's credentials 55 as they access the on-line lock 45 as shown at block 220. These users than transfer the data to the various off-line locks 80 as the various users access these locations (block 225). Each lock 80 provides confirmation of the receipt of the changes (block 230) which is passed back to the central computer 20 much the same as event data and implements the change required based on the data received (block 235). Thus, it is possible to verify that all off-line locks 80 have received the update.

The invention has been described herein as including a plurality of access points 15. While the most common application of the system and methods described herein would be to access points 15 that include doors, other types of access points 15 and combinations thereof are possible. For example, one arrangement provides security for a facility that stores materials that require additional security. In this construction, many of the access points 15 are doors, while others are material lockers, refrigerators, freezers, safes, vaults, and the like. Thus, as one of ordinary skill in the art will realize, the system and method can be applied to many different arrangements in which secure access is desired.

Thus, the invention provides, among other things, a new and useful system and method of securing a plurality of access points 15, and more particularly for transferring data to and from off-line access points 85.

What is claimed is:

1. A method of collecting data in a lock system, the method comprising:
providing each user with a credential that contains user information;
presenting the credential at an off-line access point;
reading the user information from the credential;
analyzing the user information at the first off-line access point to determine if access to the first off-line access point should be allowed;
sending event data from the off-line access point to the credential;
selectively overwriting existing event data and storing the sent event data on the credential;
presenting the credential at an on-line access point; and
reading the user data and reading the event data.

2. The method of claim 1, further comprising making an access decision at the on-line access point based at least partially on the user data.

3. The method of claim 1, further comprising storing confirmation data on the credential after reading the event data, the confirmation data corresponding to the event data.

4. The method of claim 3, further comprising re-presenting the credential at the off-line access point, the off-line access point reading the user information and the confirmation data.

5. The method of claim 4, further comprising deleting event data from the off-line access point that corresponds to the confirmation data.

6. The method of claim 1, further comprising assigning an event priority to an event at the off-line access point.

7. The method of claim 6, wherein all event data includes an event priority and wherein overwritten data has a priority that is lower than the priority of the data that replaces the overwritten data.

8. The method of claim 1, further comprising generating event data in response to an event at the off-line access point.

9. The method of claim 1, further comprising presenting the credential at a second off-line access point and storing event data from the second off-line access point on the credential.

10. The method of claim 1, further comprising storing new user information on the credential at the on-line access point and updating the off-line access point with the new user information when the credential is presented to the off-line access point.

11. A method of collecting data in a lock system in which each user possesses a credential that includes user information, the method comprising:
presenting the credential at an off-line access point;
storing event data from the off-line access point on the credential;
presenting the credential at an on-line access point;
transferring the event data from the credential through the on-line access point to a central system;
storing verification data on the credential;
re-presenting the credential at the off-line access point; and
erasing event data from the off-line access point in response to receipt of the verification data.

12. The method of claim 11, further comprising generating event data in response to an attempt to access the off-line access point.

13. The method of claim 12, further comprising assigning a priority to the event data, the priority corresponding to a type of event.

14. The method of claim 11, wherein the verification data corresponds with the event data.

15. The method of claim 11, further comprising transferring user data from the credential to the off-line access point and making an access decision at the off-line access point based at least partially on the user data.

16. The method of claim 11, further comprising storing user data on the credential, each of the on-line access point and the off-line access point determining if access should be granted at least partially based on the user data.

17. The method of claim 11, further comprising presenting the credential at a second off-line access point and storing event data from the second off-line access point on the credential.

18. The method of claim 17, further comprising assigning a priority to the event data generated at the off-line access point and the second off-line access point, and overwriting a portion of the data from the off-line access point with data from the second off-line access point that has a priority higher than the priority of the off-line access point data that is overwritten.

19. The method of claim 11, further comprising storing new user information on the credential at the on-line access point and updating the off-line access point with the new user information when the credential is presented to the off-line access point.

20. A method of collecting data in a lock system, the method comprising:
presenting a credential at an on-line access point, the credential including event data and user data;
storing the event data in a central system and storing verification data on the credential;
reading the user data and the verification data from the credential at a first off-line access point;
selectively erasing event data that corresponds to the verification data from the first off-line access point;
storing first off-line access point event data on the credential, the first off-line access point event data including a priority assigned by the first off-line access point.

21. The method of claim 20, further comprising erasing from the credential verification data that corresponds to the event data erased from the off-line access point.

22. The method of claim 20, further comprising presenting the credential at a second off-line access point, the second off-line access point reading user data from the credential for use in making an access decision, and storing event data from the second off-line access point the event data including a priority assigned by the second off-line access point.

23. The method of claim 22, further comprising overwriting event data from the first off-line access point with data from the second off-line access point that has a priority higher than the priority of the first off-line access point data that is overwritten.

24. The method of claim 20, further comprising storing new user information on the credential at the on-line access point and updating the off-line access point with the new user information when the credential is presented to the off-line access point.
